(19) United States
(12) Patent Application Publication
(10) Pub. No.: US 2007/0198746 A1
(43) Pub. Date: Aug. 23, 2007

(54) Method, system, computer programs and devices for management of media items

(76) Inventors: Tomi Myllyla, Espoo (FI); Jukka-Pekka Salmenkaita, Espoo (FI); Tapio Tallgren, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/604,343

(22) Filed: Nov. 27, 2006

Related U.S. Application Data
(63) Continuation of application No. PCT/FI04/00323, filed on May 26, 2004.

(51) Int. Cl. G06F 15/16

(52) U.S. Cl. 709/248

(57) ABSTRACT

The invention discloses a solution for synchronization of media items between a mobile terminal and another terminal device. The metadata structure (and metadata associations to media items) in the mobile terminal is updated based on the categorization work a user does in the storage system in assigning files to folders. Correspondingly, media items are rearranged in the storage system based on new metadata assignments in the mobile terminal. A media item refers e.g. to a digital picture, a sound clip, a video clip etc.

### BACKGROUND OF THE INVENTION

1. FIELD OF THE INVENTION

The present invention relates to terminal devices. In particular, the present invention relates to a novel and improved method, system, computer programs, mobile terminal and storage system for synchronization of media items stored in the mobile terminal and the storage system.

2. DESCRIPTION OF THE RELATED ART

Mobile devices, e.g. mobile phones, have become versatile and offer much more functionalities in addition to the conventional communication purpose.

A mobile device may be able to record digital pictures, sound clips, video clips etc. that are stored on the mobile device. Often digital pictures, sound clips or video clips comprise also metadata connected to each media item. A digital camera typically stores metadata relating to each digital picture. In such a case metadata contains e.g. the model of the camera, date, shutter speed, aperture value etc.

Metadata may also help a user to locate the media item but may also be important as such. It helps to recall e.g. the following aspects:
when was an image taken,
where it was taken,
who sent this video clip to me, or
who is in the picture.

Metadata information in one device can be managed and there exists solutions for this, such as different media management applications (e.g. Adobe Album). People may, however, want to use different devices, perhaps to carry the media items with them for sharing, and at the same time, for example, keep one version e.g. on a personal computer on which it is easy to store the media items.

Metadata is usually valuable for a user and means of inputting metadata (e.g. annotating and assigning categories) to the images and other media items is a significant investment of time for the enduser. Sometimes it is possible that when users input (metadata) information into some application tool, the input metadata information may not be available in a future time when the same software and hardware is no longer used. In other words, manual input of metadata information is an investment of an end-user time that has to be maximally leveraged for his or her convenience.

Some of the metadata can be embedded in the media items (e.g. Exchangeable Image File Format (EXIF), Digital Imaging Group DIG35 information). However, not all metadata is relevant to specific media items, but rather describes collections of media items, or even relations between metadata (e.g. a hierarchical categorization schemes). These types of metadata are difficult to embedded in individual media items in usable way.

At present, most of the mobile device, e.g. a digital camera or a mobile phone comprising a camera, owners are using a personal computer for longer term storing of their media items, e.g. image files. However, the memory capacity of the mobile devices is increasing rapidly and the amount of images taken is growing all the time. Already with several hundred images manual organization and transferring the images between different devices becomes rather inconvenient.

There is an obvious need for a messaging solution that would solve the aforementioned drawbacks.

### SUMMARY OF THE INVENTION

The invention discloses a solution for synchronization of media items between a mobile terminal and another terminal device. The terminal device may be another mobile terminal, a computer etc. Particularly, the invention provides a way to synchronize media item databases of two devices, and use media item metadata to automatically organize media items in both ends. A media item refers e.g. to a digital picture, a sound clip, a video clip etc.

According to one aspect of the invention there is provided a method for management of media items stored in a mobile terminal and a storage system. The method comprises storing metadata about each media item on the mobile terminal and the storage system, transmitting metadata of media items between the mobile terminal and the storage system, and synchronizing media items in the mobile terminal and storage system based on the metadata transmitted between the mobile terminal and the storage system.

Metadata refers e.g. to information that provides further information about a media item. In other words, in the invention the metadata structure (and metadata associations to media items) in the mobile terminal is updated automatically based on the categorization work a user does in the storage system in assigning files to folders. Correspondingly, media items are rearranged in the storage system based on new metadata assignments in the mobile terminal.

In one embodiment of the invention, the method further comprises categorizing media items in the storage system and updating metadata of the categorized media items in the storage system based on the categorization of the media items.

In one embodiment of the invention, the method further comprises receiving metadata of at least one media item from the mobile terminal, determining, based on the received metadata of the at least one media item, that the storage system comprises at least one media item that does not exist in the mobile terminal, transmitting metadata of the at least one media item and the at least one media item to the mobile terminal and updating a categorization scheme of media items in the mobile terminal based on the metadata of the at least one media item.

In one embodiment of the invention, the method further comprises receiving metadata of at least one media item from the mobile terminal, determining, based on the received metadata of the at least one media item, that a particular media item does not exist in the storage system, requesting the media item from the mobile terminal, and categorizing the media item in the storage system based on the received metadata of the media item.

In one embodiment of the invention, the method further comprises receiving metadata of at least one media item from the mobile terminal, determining, based on the received metadata of the at least one media item, that a particular media item exists in the storage system and that a timestamp in the metadata of the media item received from the mobile terminal is newer than a timestamp of the media item in the storage system, updating the metadata of the media item in the storage system with the metadata received from the mobile terminal, and categorizing the media item in the storage system based on the updated metadata of the media item.

Metadata of a media item may comprise more than one timestamp. For example, metadata may comprise a plurality of metadata fields, each of which having a timestamp of its own. Furthermore, a media item (e.g. a picture) itself may have a timestamp (e.g. including time and date) indicating e.g. a creation or modifying moment of the media item.

In one embodiment of the invention, the method further comprises receiving metadata of at least one media item from the mobile terminal, determining, based on the received metadata of the at least one media item, that a particular media item exists in the storage system and that a timestamp in the metadata of the media item received from the mobile terminal is older than a timestamp of the media item in the storage system, transmitting the metadata of the media item in the storage system from the storage system to the mobile terminal, and categorizing the media item in the mobile terminal based on the received metadata of the media item.

In one embodiment of the invention, the method further comprises creating at least one index file in the storage system, an index file describing at least some of the media items in the storage system and metadata associated with the media items.

In one embodiment of the invention, the method further comprises creating at least a main index file in the storage system, the main index file describing all media items in the storage system and metadata associated with the media items.

In one embodiment of the invention, the method further comprises deleting a media item in the mobile terminal or storage system, updating metadata in the mobile terminal or storage system to include a piece of information that the media item has been deleted and in the synchronization phase, not synchronizing media items that have been deleted in the mobile terminal or storage system.

In one embodiment of the invention, the method further comprises deleting a media item in the mobile terminal or storage system, updating metadata in the mobile terminal or storage system to include a piece of information that the media item has been deleted and in the synchronization phase, deleting the media item also in the other end based on the updated metadata.

In one embodiment of the invention, metadata of a media item comprises at least one of the following: location information, at least one timestamp, user-specified categories, comments, storing location, media item status and a unique identifier.

According to another aspect of the invention there is provided a computer program for management of media items in a mobile terminal, wherein the computer program comprises code adapted to perform the following steps when executed on a data-processing device:

storing metadata about each media item in the mobile terminal, the metadata comprising additional information about each media item, at least one of receiving from a storage system and transmitting to a storage system at least one of media items and metadata of media items, and categorizing media items in the mobile terminal based on the received metadata of the at least one media item.

According to another aspect of the invention there is provided a computer program for management of media items in storage system, wherein the computer program comprises code adapted to perform the following steps when executed on a data-processing device: storing metadata about each media item in the storage system, the metadata comprising additional information about each media item, at least one of receiving from a mobile terminal and transmitting to a mobile terminal at least one of media items and metadata of media items, and categorizing the media items in the storage system based on the received metadata of the media items.

According to another aspect of the invention there is provided a mobile terminal for management of media items. The mobile terminal comprises a memory configured to store at least one media item and metadata about each media item, the metadata comprising additional information each media item, a transmitter configured to transmit at least one of media items and metadata of media items to a storage system, a receiver configured to receive at least one of media items and metadata of media items from the storage system, and categorizing means configured to categorize media items in the mobile terminal based on the received metadata of the at least one media item.

In one embodiment of the invention, the receiver is configured to receive a request for at least one media item, and the transmitter is configured to send the requested at least one media item to the storage system.

According to another aspect of the invention there is provided a storage system for management of media items. The storage system comprises a memory configured to store at least one media item and metadata about each media item on the storage system, the metadata comprising additional information about each media item, a receiver configured to receive from a mobile terminal at least one of media items and metadata of media items, a transmitter configured to transmit at least one of media items and metadata of media items to the mobile terminal, and categorizing means configured to categorize media items based on the received metadata of the media items.

In one embodiment of the invention, the categorizing means are configured to categorize media items in the storage system, and the storage system further comprises updating means configured to update metadata of the categorized media items based on the categorization of the media items.

In one embodiment of the invention, the receiver is configured to receive metadata of at least one media item from the mobile terminal, the storage system further comprises determining means configured to determine, based on the received metadata of media items, that a particular media item does not exist in the storage system, the transmitter is configured to request the media item from the mobile terminal, and the categorizing means are configured to categorize the media item based on the received metadata of the media item.

In one embodiment of the invention, the receiver is configured to receive metadata of at least one media item from the mobile terminal, the storage system further comprises determining means configured to determine, based on the metadata of the at least one media item, that a particular media item exists in the storage system and that a timestamp in the metadata of the media item received from the mobile terminal is newer than a timestamp of the media item in the storage system; the storage system further comprises updating means configured to update the metadata of the media item in the storage system with the metadata received from the mobile terminal, and the categorizing means are configured to categorize the media item in the storage system based on the updated metadata of the media item.

In one embodiment of the invention, the receiver is configured to receive metadata of at least one media item from the mobile terminal, the storage system further comprises determining means configured to determine, based on the received metadata of media items, that a particular media item exists in the storage system and that a timestamp in the metadata of the media item received from the mobile terminal is older than a timestamp of the media item in the storage system, and the transmitter is configured to transmit the metadata of the media item in the storage system to the mobile terminal.

In one embodiment of the invention, the storage system further comprises creating means configured to create a new directory in the memory based on the metadata received from the mobile terminal.

In one embodiment of the invention, the storage system further comprises creating means configured to create at least one index file in the storage system, an index file describing at least some of the media items in the storage system and metadata associated with the media items.

In one embodiment of the invention, the creating means are configured to create at least a main index file in the storage system, the main index file describing all media items in the storage system and metadata associated with the media items.

According to another aspect of the invention there is provided a system for management of media items, comprising a mobile terminal comprising a first memory configured to store at least one media item and metadata about each media item, the metadata comprising additional information each media item, a first transmitter configured to transmit at least one of media items and metadata of media items to a storage system, a first receiver configured to receive at least one of media items and metadata of media items from the storage system, and first categorizing means configured to categorize media items in the mobile terminal based on the received metadata of the at least one media item, and a storage system comprising second a memory configured to store at least one media item and metadata about each media item on the storage system, the metadata comprising additional information about each media item, a second receiver configured to receive from a mobile terminal at least one of media items and metadata of media items, a second transmitter configured to transmit at least one of media items and metadata of media items to the mobile terminal, and second categorizing means configured to categorize media items based on the received metadata of the media items.

As for further characteristics of the invention, reference in made to the claims.

The invention has several advantages over the prior-art solutions. The invention provides a simple solution to synchronize media item databases of two devices, and use media item metadata to automatically organize media items in both ends.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating one embodiment of a method according to the invention, FIGS. 2a and 2b are flow diagrams illustrating another embodiment of a method according to the invention, FIG. 3 illustrates views after synchronization of media items in a mobile terminal and a storage system according to the invention, and FIG. 4 is a block diagram illustrating one embodiment of a mobile terminal and a storage device according to the invention.

### DETAILED DESCRIPTION OF THE PREFERRED EMBODIMENTS

Reference will now be made in detail to the embodiments of the present invention, examples of which are illustrated in the accompanying drawings.

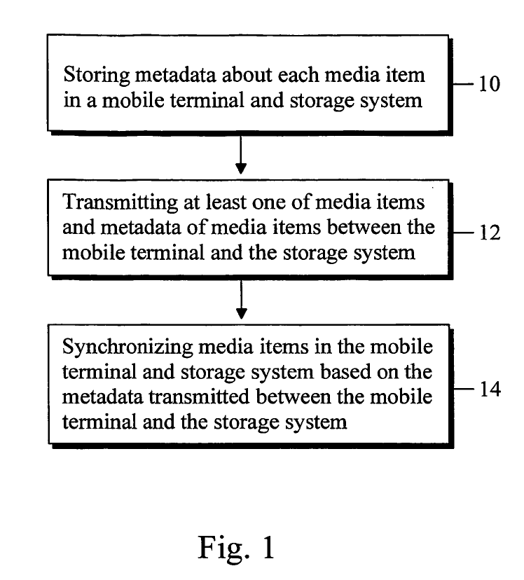

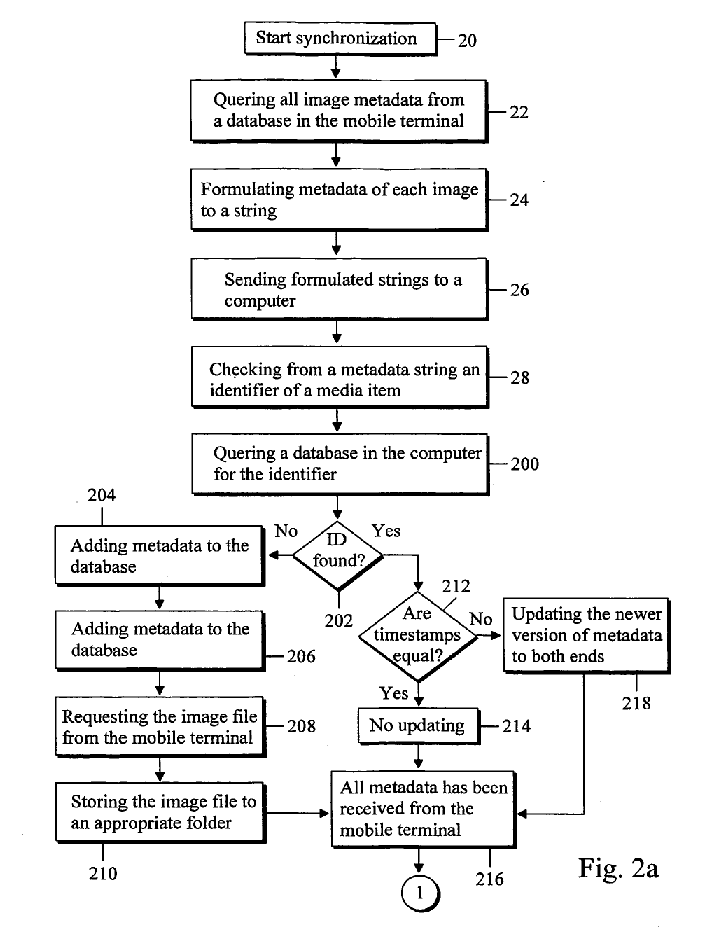

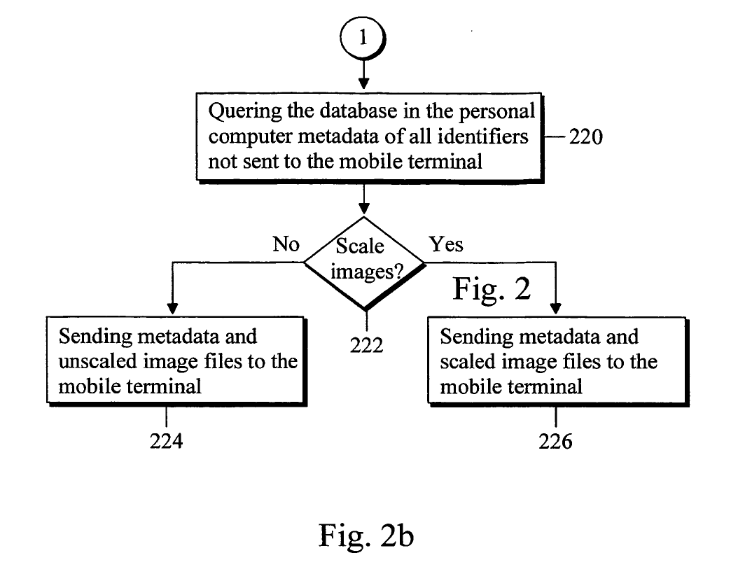

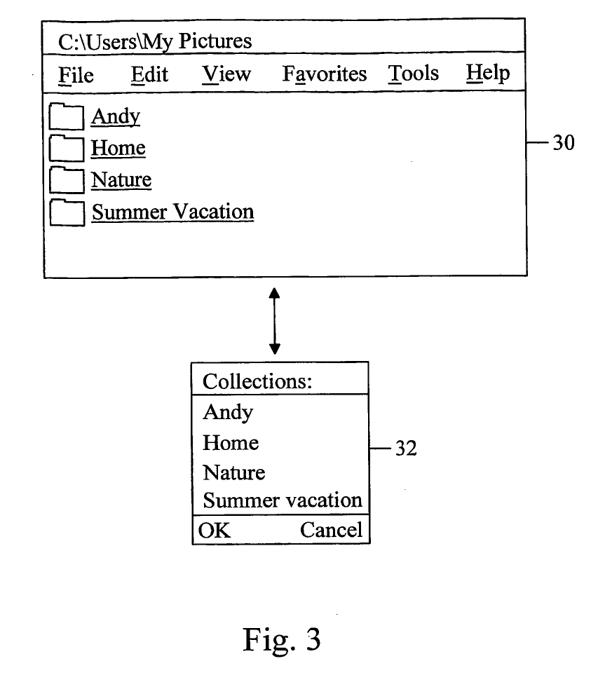

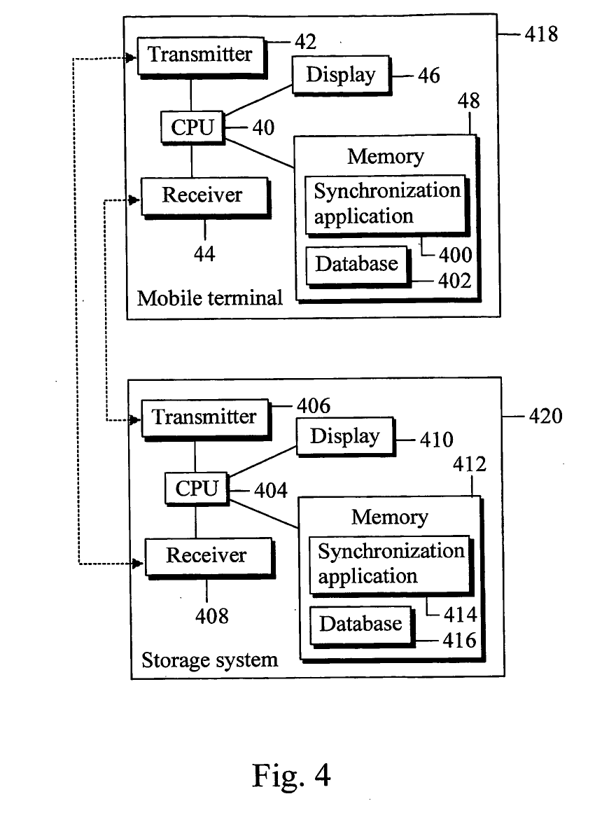

FIG. 1 is a flow diagram illustrating one embodiment of a method according to the invention. Particularly, FIG. 1 discloses a method for management of media items stored in a mobile terminal and a storage system. As indicated at step 10, metadata about each media item is stored in the mobile terminal and storage system. The metadata comprises information e.g. about the grouping of the media items in the mobile terminal and storage system. At least one of media items and metadata of media items is transmitted between the mobile terminal and the storage system, step 12. Media items in the mobile terminal and storage device are synchronized based on the metadata transmitted between the mobile terminal and storage system, step 14. Changes in media items in the storage system are preferably recognized before the synchronization starts.

FIGS. 2a and 2b disclose one embodiment for synchronizing a mobile terminal and a computer according to the invention. This embodiment uses a digital picture as an example of a media item.

The mobile terminal comprises a camera application that is able to save metadata to a database, e.g. a Structured Query Language (SQL) database, along with taken images. The metadata may include one or more of the following pieces of information: location information (based on e.g. cell identifiers, location area codes and country codes)), timestamps (date and time of a media item), permanent storing location, user-specified categories, caption, comments, media item status and a unique 32-bit identifier for every snapped image.

Furthermore, the mobile terminal comprises an image management application that is able to leverage the use of image metadata in its features in querying and organizing images. Using the image management application, it is possible to group images by location, assign named locations to certain cell identifiers and location area codes, create and assign collections for images and search images with specific metadata information.

In order to synchronize a mobile terminal and a computer the mobile terminal and the computer comprise a synchronization application. In this embodiment, the synchronization application in the mobile terminal acts as a synchronization client and it utilizes Bluetooth communication protocol for sending and receiving images and metadata to/from the computer. The synchronization client is e.g. a Symbian application. The synchronization application in the computer acts as a synchronization server that has to be started before synchronization can occur.

In synchronization, the Bluetooth communication protocol is used with RFCOMM serial port profile to transfer images and metadata between the mobile terminal and the computer. The synchronization client establishes the connection with the computer to a certain serial port that is emulated by the RFCOMM protocol. The synchronization server in the computer listens the serial port and receiver/sends synchronization data.

A user of the mobile terminal starts the synchronization client in the terminal and selects the Bluetooth device to synchronize with, step 20. In this embodiment, this device is a computer. The synchronization client application detects that the synchronization server application is running in the computer. When the user starts the synchronization server application in the computer he/she also selects the synchronization folder that is used to store images. Changes in media items, e.g. images, in the storage system are preferably recognized before the synchronization starts.

Before the actual synchronization procedure starts, databases in the both ends are queried through and checked that the images actually exist, and a piece of information may be added to metadata if a media item has been deleted from the according database.

In one embodiment a media item has been deleted in the mobile terminal or storage system. The mobile terminal or storage system may comprise an index file that includes information, e.g. metadata, of media items. When a media item is deleted, metadata of the deleted media item is not deleted. The metadata is updated so that it indicates that the media item has been deleted (media item status). This piece of information can be used in the synchronization procedure. In the synchronization procedure media item status information may be utilized, and if the status information indicates that a media item has been deleted in one end, the media item is deleted also in the other end. Alternatively, in the synchronization procedure a media item is not to be synchronized if media item the status information indicates that the media item has been deleted earlier.

In addition, in the computer all images in the synchronization folder or in any subfolders under that are added to the database if they are not already included there. A 32-bit random identifier and a checksum from image pixels are generated for every image to be stored in the database. Using the checksum, it is possible to check whether the user has moved an image from one folder to another, and just update metadata information instead of adding the image to the database with a new unique identifier that would mess up the synchronization.

When adding images to the database or updating metadata information in the computer the name of the lowest subfolder of the image is saved to a collection field of the image metadata so that the image management application in the mobile terminal is able to use the metadata in the grouping of images in the mobile terminal. The term collection refers to a categorization scheme that is used in the mobile terminal. A collection may be regarded equal with a folder in the computer.

The image management application queries metadata of all images from the database in the mobile terminal, step 22. The metadata of each image is formulated to a separate string and the strings are sent to the computer, step 26.

When the synchronization application server in the computer receives the metadata strings from the mobile terminal it first checks the 32-bit unique identifier of the incoming image metadata, step 28. The identifier is queried from the database in the computer, step 200. In this embodiment, there are three possible results for query:
1. If the identifier is not found from the database in the computer the metadata is added to database, steps 200 and 202. The metadata of the corresponding image is then added to the database, step 206. Furthermore, the image file relating to the identifier is requested from the mobile terminal, step 208. The received image file is saved to the synchronization folder, step 210. Particularly, the image is saved to the synchronization folder under a subfolder that corresponds to the collection that the image has been assigned in the image management application in the mobile terminal. The image may be saved to the root of the synchronization folder is the image has.not been assigned to any collection in the image management application in the mobile terminal.
2. If the identifier and metadata are found from the database in the computer but a timestamp in the metadata in the database differs from a timestamp of the received metadata, a newer version of metadata is updated to both ends, steps 202, 212 and 218. In this embodiment, if the computer has newer metadata it marks the metadata of corresponding image to be sent in the later phase of the synchronization to the mobile terminal. The synchronization algorithm is dynamic, so that modified collection/folder structures are handled properly with synchronization application that is able to move images from one folder to another in the computer automatically and alter collections in the mobile terminal with changed folder structures in the computer (for example, if the user moves images from one folder to another in the computer).
3. If the identifier and metadata are found from the database in the computer and a timestamp in the metadata in the database matches with a timestamp of the received metadata nothing has to be updated.

Furthermore, metadata of a media item may comprise more than one timestamp. For example, metadata may comprise a plurality of metadata fields, each of which having a timestamp of its own. Furthermore, a media item (e.g. a picture) itself may have a timestamp (e.g. including time and date) indicating e.g. a creation or modifying moment of the media item.

When the synchronization server application in the computer has received all the metadata from the mobile terminal (step 216) it queries metadata of all the identifiers that was not received from the mobile terminal from the database, step 220. The synchronization server application queries from the database also metadata that has newer timestamps in the computer. The queried metadata is sent to the mobile terminal in the same way as the mobile terminal sent metadata to the computer. The computer sends to the mobile terminal also image files that do not exist in the mobile terminal, steps 222 and 224.

If the image size is above a specified resolution (e.g. 640×480) in the computer application (or any specified resolution in the PC application) the image may be scaled down for sending to save memory space in the mobile terminal and for speeding up the transfer, steps 222 and 226.

In one embodiment of FIG. 2, media items can be modified before synchronization. Modifications are made e.g. based on metadata of media items. For example, when media item are to be sent to the mobile terminal, it is possible to include a smaller version of a media item to be sent to the mobile terminal in order to conserve space in the mobile terminal.

FIG. 3 represents one embodiment of possible views in the computer and mobile terminal after synchronization. A view 30 is a simplified view of a folder structure in the computer. In this embodiment folder ‘My pictures’ in the computer is a synchronization folder that comprises four subfolders. A view 32 is a simplified view of collections in the mobile terminal.

Currently collections are synchronized to folders and vice versa. However, it is also possible to utilize location and time based metadata information when automatically organizing images in the computer. All users may not use collections in the mobile terminal and they want subfolders to be created according to locations and dates during the synchronization. Furthermore, images that are assigned to collections are typically placed in proper subfolders in the computer, and other images are placed at the main level in synchronization directory.

FIG. 4 is a block diagram illustrating one embodiment of a mobile terminal and a storage device according to the invention. It is evident that the devices may comprise also other hardware and/or software components that are not shown in FIG. 4.

A mobile terminal 418 is e.g. a mobile phone, digital camera or Personal Digital Assistant (PDA). A storage system 420 refers e.g. to a personal computer. Storage system 420 may also refer to another mobile terminal.

Mobile terminal 418 comprises a central processing unit 40 that is connected to a memory 48, a transmitter 42 and a receiver 44. Memory 48 comprises at least a synchronization application 400 and a database 402. Transmitter 42 and receiver 44 refer e.g. to a Bluetooth device that is able to send and receive metadata information and media items to/from storage system 420. Database 402 comprises stored metadata along with media items. The metadata may include at least one of the following pieces of information: location information (based e.g. on cell identifier, location area codes and country codes), timestamps (date and time of a media item), permanent storing location, user-specified categories, caption, comments, media item status and a unique 32-bit identifier for every media item.

Mobile terminal 418 further comprises categorizing means 400 configured to categorize media items based on received metadata from storage system 420.

In one embodiment receiver 44 is configured to receive a request for at least one media item from storage system 420 and transmitter 42 is configured to send the requested at least one media item to storage system 420.

Storage system 420 comprises a central processing unit 404 that is connected to a memory 412, a transmitter 406 and a receiver 408. Memory 412 comprises at least a synchronization application 412 and a database 416. Transmitter 406 and receiver 408 refer e.g. to a Bluetooth device that is able to send and receive data metadata information and/or media items to/from mobile terminal 418. Database 416 comprises stored metadata along with media items. The metadata may include one or more of the following pieces of information: location information (based e.g. on cell identifier, location area codes and country codes), timestamps (date and time of a media item), permanent storing location, user-specified categories, caption, comments, media item status and a unique 32-bit identifier for every media item.

Storage system 420 further comprises categorizing means 414 configured to categorize media items based on the received metadata of media items from mobile terminal 418. In one embodiment, storage system 420 further comprises updating means 414 configured to update metadata of categorized media items based on the categorization of the media items.

In one embodiment receiver 408 is configured to receive metadata of at least one media item from mobile terminal 418. Storage system 420 further comprises determining means 414 configured to determine, based on the received metadata of media items, that a particular media item does not exist in storage system 420. Therefore, transmitter 406 is configured to request the media item from mobile terminal 148 and categorizing means 414 are configured to categorize the media item based on the received metadata of the media item.

In another embodiment receiver 408 is configured to receive metadata of at least one media item from mobile terminal 418. Storage system 420 further comprises determining means 414 configured to determine, based on the metadata of the at least one media item, that a particular media item exists in storage system 420 and that a timestamp in the metadata of the media item received from the mobile terminal is newer than a timestamp of the media item the storage system 420. Therefore, storage system 420 further comprises updating means 414 configured to update the metadata of the media item in storage system 420 with the metadata received from mobile terminal 418, and the categorizing means 414 are configured to categorize the media item in storage system 420 based on the updated metadata of the media item.

In another embodiment receiver 408 is configured to receive metadata of at least one media item from mobile terminal 418. Storage system 420 further comprises determining means 414 configured to determine, based on the received metadata of media items, that a particular media item exists in storage system 420 and that a timestamp in the metadata of the media item received from mobile terminal 418 is older than a timestamp of the media item in storage system 420. Transmitter 406 is configured to transmit the metadata of the media item in storage system 420 to mobile terminal 418.

In one embodiment storage system 420 further comprises creating means 414 configured to create a new directory in memory 412 based on-the metadata received from mobile terminal 418. Creating means 414 may be configured to create at least one index file in memory 412. An index file describes at least some of the media items in memory 412 and metadata associated with the media items. In another embodiment, creating means 414 may be configured to create at least a main index file in memory 412. The main index file describes all media items stored in memory 412 and metadata associated with the media items. The main index file may also include a piece of information that indicated whether a particular media item exists in the storage system or it has been deleted. In other words, although the actual media item may not be stored any more in the storage system, the corresponding metadata may still be preserved with the exception that the media item is marked as deleted.

Memories 48 and 412 may refer to a single memory or memory area or to a plurality memories or memory areas that may include e.g. random access memories (RAM), read-only memories (ROM) etc. Memory 412 may also include other applications or software components that are not described in more detail and also may include the computer program (or portion thereof), which when executed on the CPU 40 or 404 performs at least some of the steps of the method steps of the invention. CPU 40 or 404 may also include memory or a memory may be associated therewith which may include the computer program (or portion thereof) which when executed on CPU 40 or 404 performs at least some of the method steps of the invention.

It is obvious to a person skilled in the art that with the advancement of technology, the basic idea of the invention may be implemented in various ways. The invention and its embodiments are thus not limited to the examples described above, instead they may vary within the scope of the claims.

We claim:

1. A method for management of media items stored in a mobile terminal and a storage system, the method comprising:
storing metadata about each media item in the mobile terminal and the storage system, the metadata comprising additional information about each media item;
transmitting at least one of media items and metadata of media items between the mobile terminal and the storage system; and
synchronizing media items in the mobile terminal and storage system based on the metadata transmitted between the mobile terminal and the storage system.

2. The method according to claim 1, further comprising:
categorizing media items in the storage system; and
updating metadata of the categorized media items in the storage system based on the categorization of the media items.

3. The method according to claim 1, further comprising:
receiving metadata of at least one media item from the mobile terminal;
determining, based on the received metadata of the at least one media item, that the storage system comprises at least one media item that does not exist in the mobile terminal;
transmitting metadata of the at least one media item and the at least one media item to the mobile terminal; and
updating a categorization scheme of media items in the mobile terminal based on the metadata of the at least one media item.

4. The method according to claim 1, further comprising:
receiving metadata of at least one media item from the mobile terminal;
determining, based on the received metadata of the at least one media item, that a particular media item does not exist in the storage system;
requesting the media item from the mobile terminal; and
categorizing the media item in the storage system based on the received metadata of the media item.

5. The method according to claim 1, further comprising:
receiving metadata of at least one media item from the mobile terminal;
determining, based on the received metadata of the at least one media item, that a particular media item exists in the storage system and that a timestamp in the metadata of the media item received from the mobile terminal is newer than a timestamp of the media item in the storage system;
updating the metadata of the media item in the storage system with the metadata received from the mobile terminal; and
categorizing the media item in the storage system based on the updated metadata of the media item.

6. The method according to claim 1, further comprising:
receiving metadata of at least one media item from the mobile terminal;
determining, based on the received metadata of the at least one media item, that a particular media item exists in the storage system and that a timestamp in the metadata of the media item received from the mobile terminal is older than a timestamp of the media item in the storage system;
transmitting the metadata of the media item in the storage system from the storage system to the mobile terminal; and
categorizing the media item in the mobile terminal based on the received metadata of the media item.

7. The method according to claim 1, further comprising:
creating a new directory in the storage system based on the metadata received from the mobile terminal.

8. The method according to claim 1, further comprising:
creating at least one index file in the storage system, an index file describing at least some of the media items in the storage system and metadata associated with the media items.

9. The method according to claim 8, further comprising:
creating at least a main index file in the storage system, the main index file describing all media items in the storage system and metadata associated with the media items.

10. The method according to claim 1, further comprising:
deleting a media item in the mobile terminal or storage system;
updating metadata in the mobile terminal or storage system to include a piece of information that the media item has been deleted; and
in the synchronization phase, not synchronizing media items that have been deleted in the mobile terminal or storage system.

11. The method according to claim 1, further comprising:
deleting a media item in the mobile terminal or storage system;
updating metadata in the mobile terminal or storage system to include a piece of information that the media item has been deleted; and
in the synchronization phase, deleting the media item also in the other end based on the updated metadata.

12. The method according to claim 1, wherein metadata of a media item comprises at least one of the following:
location information;
at least one timestamp;
user-specified categories;
comments;
storing location;
media item status; and
a unique identifier.

13. A computer program for management of media items in a mobile terminal, wherein the computer program comprises code adapted to perform the following steps when executed on a data-processing device:
storing metadata about each media item in the mobile terminal, the metadata comprising additional information about each media item;
at least one of receiving from a storage system and transmitting to a storage system at least one of media items and metadata of media items; and
categorizing media items in the mobile terminal based on the received metadata of the at least one media item.

14. The computer program according to claim 13, further adapted to perform the following steps when executed on a data-processing device:
receiving a request for at least one media item from the storage system; and
sending the requested at least one media item to the storage system.

15. The computer program according to claim 13, further adapted to perform the following steps when executed on a data-processing device:
deleting a media item in the mobile terminal;
updating metadata in the mobile terminal to include a piece of information that the media item has been deleted; and
in the synchronization phase, not synchronizing media items that have been deleted in the mobile terminal.

16. The computer program according to claim 13, further adapted to perform the following steps when executed on a data-processing device:
deleting a media item in the mobile terminal;
updating metadata in the mobile terminal to include a piece of information that the media item has been deleted; and
in the synchronization phase, deleting the media item also in the storage system based on the updated metadata.

17. The computer program according to claim 13, wherein metadata of a media item comprises at least one of the following:
location information;
at least one timestamp;
user-specified categories;
comments;
storing location;
media item status; and
a unique identifier

18. The computer program according to claim 13, wherein the computer program is stored on a data-processing device readable medium.

19. A computer program for management of media items in a storage system, wherein the computer program comprises code adapted to perform the following steps when executed on a data-processing device:
storing metadata about each media item in the storage system, the metadata comprising additional information about each media item;
at least one of receiving from a mobile terminal and transmitting to a mobile terminal at least one of media items and metadata of media items; and
categorizing the media items in the storage system based on the received metadata of the media items.

20. The computer program according to claim 19, further adapted to perform the following steps when executed on a data-processing device:
categorizing media items in the storage system; and
updating metadata of the categorized media items based on the categorization of the media items.

21. The computer program according to claim 19, further adapted to perform the following steps when executed on a data-processing device:
receiving metadata of at least one media item from the mobile terminal;
determining, based on the received metadata of the at least one media item, that a particular media item does not exist in the storage system;
updating the metadata of the media item in the storage system with the metadata received from the mobile terminal; and
categorizing the media item in the storage system based on the updated metadata of the media item.

22. The computer program according to claim 19, further adapted to perform the following steps when executed on a data-processing device:
receiving metadata of at least one media item from the mobile terminal;
determining, based on the metadata of the at least one media item, that a particular media item exists in the storage system and that a timestamp in the metadata of the media item received from the mobile terminal is newer than a timestamp of the media item in the storage system, updating the metadata of the media item in the storage system with the metadata received from the mobile terminal; and
categorizing the media item in the storage system based on the updated metadata of the media item.

23. The computer program according to claim 19, further adapted to perform the following steps when executed on a data-processing device:
receiving metadata of at least one media item from the mobile terminal;
determining, based on the received metadata of the at least one media item, that a particular media exists in the storage system and that a timestamp in the metadata of the media item received from the mobile terminal is older than a timestamp of the media item in the storage system; and
transmitting the metadata of the media item in the storage system to the mobile terminal.

24. The computer program according to claim 19, further adapted to perform the following steps when executed on a data-processing device:
creating a new directory in the storage system based on the metadata received from the mobile terminal.

25. The computer program according to claim 19, further adapted to perform the following steps when executed on a data-processing device:
creating at least one index file in the storage system, an index file describing at least some of the media items in the storage system and metadata associated with the media items.

26. The computer program according to claim 25, further adapted to perform the following steps when executed on a data-processing device:
creating at least a main index file in the storage system, the main index file describing all media items in the storage system and metadata associated with the media items.

27. The computer program according to claim 19, further adapted to perform the following steps when executed on a data-processing device:
deleting a media item in the storage system;
updating metadata in the storage system to include a piece of information that the media item has been deleted; and
in the synchronization phase, not synchronizing media items that have been deleted in the storage system.

28. The computer program according to claim 19, further adapted to perform the following steps when executed on a data-processing device:
deleting a media item in the storage system;
updating metadata in the storage system to include a piece of information that the media item has been deleted; and
in the synchronization phase, deleting the media item also in the mobile terminal based on the updated metadata.

29. The computer program according to claim 19, wherein metadata of a media item comprises at least one of the following:
location information;
at least one timestamp;
user-specified categories;
comments;
storing location;
media item status; and
a unique identifier.

30. The computer program according to claim 19, wherein the computer program is stored on a data-processing device readable medium.

31. A mobile terminal for management of media items, comprising:
a memory configured to store at least one media item and metadata about each media item, the metadata comprising additional information each media item;
a transmitter configured to transmit at least one of media items and metadata of media items to a storage system;
a receiver configured to receive at least one of media items and metadata of media items from the storage system; and
categorizing means configured to categorize media items in the mobile terminal based on the received metadata of the at least one media item.

32. The mobile terminal according to claim 31, wherein:
the receiver is configured to receive a request for at least one media item; and
the transmitter is configured to send the requested at least one media item to the storage system.

33. The mobile terminal according to claim 31, wherein the categorizing means are configured to delete a media item, to update metadata in the memory to include a piece of information that the media item has been deleted; and in a synchronization phase, not to synchronize media items that have been deleted in the mobile terminal.

34. The mobile terminal according to claim 31, wherein:
the categorizing means are configured to delete a media item, to update metadata in the memory to include a piece of information that the media item has been deleted; and
in a synchronization phase, the transmitter is configured to send the updated metadata to the storage system.

35. The mobile terminal according to claim 31, wherein metadata of a media item comprises at least one of the following:
location information;
at least one timestamp;
user-specified categories;
comments;
storing location;
media item status; and
a unique identifier.

36. A storage system for management of media items, comprising:
a memory configured to store at least one media item and metadata about each media item on the storage system, the metadata comprising additional information about each media item;
a receiver configured to receive from a mobile terminal at least one of media items and metadata of media items;
a transmitter configured to transmit at least one of media items and metadata of media items to the mobile terminal; and
categorizing means configured to categorize media items based on the received metadata of the media items.

37. The storage system according to claim 36, wherein:
categorizing means are configured to categorize media items in the storage system; and
the storage system further comprises updating means configured to update metadata of the categorized media items based on the categorization of the media items.

38. The storage system according to claim 36, wherein:
the receiver is configured to receive metadata of at least one media item from the mobile terminal;
the storage system further comprises determining means configured to determine, based on the received metadata of media items, that a particular media item does not exist in the storage system;
the transmitter is configured to request the media item from the mobile terminal; and
the categorizing means are configured to categorize the media item based on the received metadata of the media item.

39. The storage system according to claim 36, wherein:
the receiver is configured to receive metadata of at least one media item from the mobile terminal;
the storage system further comprises determining means configured to determine, based on the metadata of the at least one media item, that a particular media item exists in the storage system and that a time-stamp in the metadata of the media item received from the mobile terminal is newer than a timestamp of the media item in the storage system;
the storage system further comprises updating means configured to update the metadata of the media item in the storage system with the metadata received from the mobile terminal; and
the categorizing means are configured to categorize the media item in the storage system based on the updated metadata of the media item.

40. The storage system according to claim 36, wherein:
the receiver is configured to receive metadata of at least one media item from the mobile terminal;
the storage system further comprises determining means configured to determine, based on the received metadata of media items, that a particular media item exists in the storage system and that a timestamp in the metadata of the media item received from the mobile terminal is older than a timestamp of the media item in the storage system; and
the transmitter is configured to transmit the metadata of the media item in the storage system to the mobile terminal.

41. The storage system according to claim 36, further comprising creating means configured to create a new directory in the memory based on the metadata received from the mobile terminal.

42. The storage system according to claim 36, further comprising creating means configured to create at least one index file in the storage system, an index file describing at least some of the media items in the storage system and metadata associated with the media items.

43. The storage system to claim 42, wherein the creating means are configured to create at least a main index file in the storage system, the main index file describing all media items in the storage system and metadata associated with the media items.

44. The storage system to claim 36, wherein the categorizing means are configured to delete a media item, to update metadata in the memory to include a piece of information that the media item has been deleted; and in a synchronization phase, not to synchronize media items that have been deleted in the storage system.

45. The storage system to claim 36, wherein:
the categorizing means are configured to delete a media item, to update metadata in the memory to include a piece of information that the media item has been deleted; and
in a synchronization phase, the transmitter is configured to send the updated metadata to the mobile terminal.

46. The storage system to claim 36, wherein metadata of a media item comprises at least one of the following:
location information;
at least one timestamp;
user-specified categories;
comments;
storing location;
media item status; and
a unique identifier.

47. A system for management of media items, comprising:
a mobile terminal comprising a first memory configured to store at least one media item and metadata about each media item, the metadata comprising additional information each media item, a first transmitter configured to transmit at least one of media items and metadata of media items to a storage system, a first receiver configured to receive at least one of media items and metadata of media items from the storage system, and first categorizing means configured to categorize media items in the mobile terminal based on the received metadata of the at least one media item; and
a storage system comprising second a memory configured to store at least one media item and metadata about each media item on the storage system, the metadata comprising additional information about each media item, a second receiver configured to receive from a mobile terminal at least one of media items and metadata of media items, a second transmitter configured to transmit at least one of media items and metadata of media items to the mobile terminal, and second categorizing means configured to categorize media items based on the received metadata of the media items.

48. The system according to claim 47, wherein:
the fist receiver is configured to receive a request for at least one media item; and
the first transmitter is configured to send the requested at least one media item to the storage system.

49. The system according to claim 47, wherein:
the second categorizing means are configured to categorize media items in the storage system, and the storage system further comprises updating means configured to update metadata of the categorized media items based on the categorization of the media items.

50. The system according to claim 47, wherein:
the first transmitter is configured to send metadata of at least one media item to the storage system;
the second receiver is configured to receive the metadata of the at least one media item from the mobile terminal;
the storage system further comprises determining means configured to determine, based on the received metadata of media items, that a particular media exists in the storage system and that a timestamp in the metadata of the media item received from the mobile terminal is older than a timestamp of the media item in the storage system;
the second transmitter is configured to transmit updated metadata of the media item to the mobile terminal;
the first receiver is configured to receive the updated metadata of the media item; and
the first categorizing means are configured to update a categorization scheme of media items in the mobile terminal based on the received metadata of the at least one media item.

51. The system according to claim 47, further comprising:
the first transmitter is configured to send metadata of at least one media item to the storage system;
the second receiver is configured to receive the metadata of the at least one media item from the mobile terminal;
the storage system further comprises determining means configured to determine, based on the received metadata of media items, that a particular media item does not exist in the storage system;
the second transmitter is configured to request the media item from the mobile terminal;
the first receiver is configured to receive the request;
the first transmitter is configured to send the requested media item to the storage system;
the second receiver is configured to receive the media item; and
the second categorizing means are configured to categorize the media item based on the received metadata of the media item.

52. The system according to claim 47, further comprising:
the first transmitter is configured to send metadata of at least one media item to the storage system;
the second receiver is configured to receive the metadata of the at least one media item from the mobile terminal;
the storage system further comprises determining means configured to determine, based on the metadata of the at least one media item, that a particular media item exists in the storage system and that a time-stamp in the metadata of the media item received from the mobile terminal is newer than a timestamp of the media item in the storage system;
updating means configured to update the metadata of the media item in the storage system with the metadata received from the mobile terminal; and
the second categorizing means are configured to categorize the media item in the storage system based on the updated metadata of the media item.

53. The system according to claim 47, further comprising:
the first transmitter is configured to send metadata of at least one media item to the storage system;
the second receiver is configured to receive the metadata of the at least one media item from the mobile terminal;
the storage system further comprises determining means configured to determine, based on the received metadata of media items, that a particular media item exists in the storage system and that a timestamp in the metadata of the media item received from the mobile terminal is older than a timestamp of the media item in the storage system;
the second transmitter is configured to transmit the metadata of the media item in the storage system to the mobile terminal;
the first receiver is configured to receive the metadata from the storage system; and
the first categorizing means are configured to categorize the media item in the mobile terminal based on the received metadata of the media item.

54. The system according to claim 47, further comprising creating means configured to create a new directory in the second memory based on the metadata received from the mobile terminal.

55. The system according to claim 47, further comprising creating means configured to create at least one index file in the storage system, an index file describing at least some of the media items in the storage system and metadata associated with the media items.

56. The system to claim 55, wherein the creating means are configured to create at least a main index file in the storage system, the main index file describing all media items in the storage system and metadata associated with the media items.

57. The system to claim 47, wherein the at least one of first and second categorizing means are configured to delete a media item, to update metadata in the at least one of first and second memory to include a piece of information that the media item has been deleted; and in a synchronization phase, not to synchronize media items that have been deleted.

58. The storage system to claim 47, wherein:
the at least one of first and second categorizing means are configured to delete a media item, to update metadata in the at least one of first and second memory to include a piece of information that the media item has been deleted; and
in a synchronization phase, the at least one of first and second transmitter is configured to send the updated metadata.

59. The system to claim 47, wherein metadata of a media item comprises at least one of the following:
location information;
at least one timestamp;
user-specified categories;
comments;
storing location;
media item status; and
a unique identifier.
